(19) United States
(12) Patent Application Publication
(10) Pub. No.: US 2003/0000781 A1
(43) Pub. Date: Jan. 2, 2003

(54) Magnetorheological damper piston with bypass valving

(75) Inventors: Michael L. Oliver, Xenia, OH (US); William C. Kruckmeyer, Beavercreek, OH (US); Todd A. Bishop, Centerville, OH (US)

Correspondence Address: SCOTT A. MCBAIN, DELPHI TECHNOLOGIES, INC., P.O. BOX 5052, 1450 W. Long Lake, Mail Code: 482-204-450, Troy, MI, 48098, US

(73) Assignee: DELPHI TECHNOLOGIES, INC.

(21) Appl. No.: 09/894,443

(22) Filed: Jun. 28, 2001

(51) Int. Cl. F16F 9/34

(52) U.S. Cl. 188/267.2; 188/282.1

(57) ABSTRACT

An adjustable vehicle suspension damper configured to be arranged between a wheel assembly and a body of a vehicle, the adjustable damper including a tube. A piston is slidably carried in the tube. A coil is carried on the piston adjacent a first flow passageway in the piston to produce a magnetic field thereacross and a control valve is carried on the piston controlling fluid flow through a second flow passageway in the piston.

### TECHNICAL FIELD

In general, the invention relates to damper assemblies for use in vehicle suspension systems, and more particularly, to a damper piston including a bypass valve assembly for a damper or magnetorheological shock absorber or monotube strut.

### BACKGROUND OF THE INVENTION

Current vehicle suspensions frequently incorporate dampers, i.e., shock absorber and strut assemblies as both a damping device and, in some applications, part of the suspension's load bearing structure. Dampers are conventionally known which include a piston with a connected piston rod. The piston is slidably contained in a fluid filled tube or chamber.

Vehicle suspension dampers, used to control vehicle ride and handling, typically contain control valves tuned to control vehicle jounce (compression of damper) and rebound damping (extension of damper) independently. It is generally known that it is desirable to have jounce damping set at approximately one-half to one-third the level of rebound damping. In a current design damper provided with magnetorheological features, damping can be externally controlled. Generally, this is accomplished by providing the damper with a magnetorheological fluid, which when exposed to a magnetic field, provides a condition of increased resistance to flow or apparent viscosity in the damper, and thus an increased damping effect. However, the range of damping available from the damper is the same for jounce and rebound.

It would be desirable to provide jounce and rebound control that overcomes the above and other disadvantages.

### SUMMARY OF THE INVENTION

One aspect of the present invention provides an adjustable vehicle suspension damper assembly configured to be arranged between a wheel assembly and a body of a vehicle, the adjustable damper including a tube. A piston is slidably positioned in the tube. A coil is positioned on the piston adjacent a first flow passageway in the piston to produce a magnetic field thereacross and a control valve is operably attached to the piston to control fluid flow through a second flow passageway in the piston.

Other aspects of the present invention provide the first flow passageway and tube with a magnetorheological fluid. The magnetic field can be produced across the first flow passageway to change the apparent viscosity of at least a portion of the magnetorheological fluid present therein. The control valve may be permitted to open during compression strokes of the damper. The control valve may be substantially closed during extension strokes of the damper. The control valve can include a first disc that permits a first amount of flow through the control valve during both compression strokes and extension strokes of the damper. The first disc can be a washer including a plurality of outer notches. The first disc may permit a second amount of flow through the control valve during compression strokes, the first amount of flow being less than the second amount of flow.

A spring member can bias the first disc against a valve seat portion of the control valve. The spring member can be a wavy washer or a Belleville washer. The second disc can be positioned between the first disc and the spring member. The second disc can be a solid washer. The control valve may include a retaining member positioned to retain the spring member and the first disc against the valve seat portion. The spacer can be positioned between the retaining member and the spring member. The spacer may provide a predetermined preload to the spring member.

Another aspect of the present invention provides a method of controlling an adjustable damper including enclosing a piston in a magnetorheological fluid, producing a magnetic field in a first passageway of the piston and controlling the flow through a second passageway of the piston. Controlling the flow through the second passageway may include providing a first flow through the second passageway during an extension stroke and providing a second flow through during a compression stroke, the first flow being substantially less than the second flow.

Another aspect of the present invention provides an adjustable damper including a means for slidably enclosing a piston in a magnetorheological fluid, a means for producing a magnetic field in a first passageway of the piston and a means for controlling the flow through a second passageway of the piston. The means for controlling the flow through the second passageway can provide a first flow through the second passageway during an extension stroke and provides a second flow through during a compression stroke, the first flow being substantially less than the second flow.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a cross-sectional view of a prior art monotube damper suitable for use with the piston assembly of the present invention.

FIG. 2 is a side view of one embodiment of the damper piston assembly of the present invention.

FIG. 3 is a cross-sectional view of the embodiment shown in FIG. 2 along lines 3-3.

FIG. 4 is an exploded perspective view of one embodiment of the damper piston assembly of the present invention.

### DETAILED DESCRIPTION OF THE PRESENTLY PREFERRED EMBODIMENTS

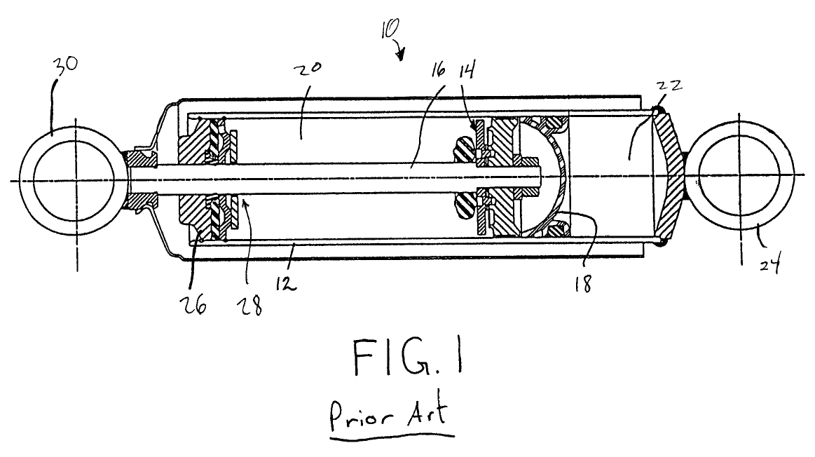

Referring to FIG. 1, a prior art vehicle damper assembly suitable for use with the piston assembly of the present invention is shown to illustrate the general elements and operation of one embodiment of a monotube damper. One embodiment of the monotube damper is shown generally at 10. Damper 10 may include a body 12, a piston 14, a rod 16, a gas cup 18, a fluid chamber 20 and a gas chamber 22.

The body 12 may be a generally cylindrical shape with a first closed-end including a vehicle attachment 24. A second closed-end of the body 12 can include seal 26 with opening 28 through which an end of the rod 16 can project. The projecting end of the rod 16 can include attachment 30. Piston 14 can be attached to the end of the rod 16 opposite attachment portion 30. Piston 14 is positioned inside the body 12 and slides reciprocally therein, providing the interior of the body into fluid chamber 20 and gas chamber 22. Piston 14 can include orifices or valves (not shown) to impart various controllable damping characteristics to the damper.

Gas cup 18 can be located between the piston 14 and the attachment end of body 12 and can be provided with a seal as is known in the art. Gas cup 18 can also slide within body 12. Fluid chamber 20 defined by gas cup 18, body 12 and seal 26 can be filled with a damping fluid. Chamber 22 can be filled with gas, typically a compressed inert gas, such as Nitrogen.

When the monotube damper 10 is stroked, damping fluid is forced through orifices and/or valves in the piston 14, providing flow damping and therefore motion damping. The pressurized gas in chamber 22 presses the gas cup 18 toward damping fluid chamber 20, pressurizing the fluid, and making the damper resistant to fluid cavitation. Also, when the damper is stroked, the rod 16 displaces damping fluid inside the body 12, causing the gas cup 18 to move. For example, as a unit 10 is stroked shorter, the gas cup 18 is forced towards the attachment end 24 of the body.

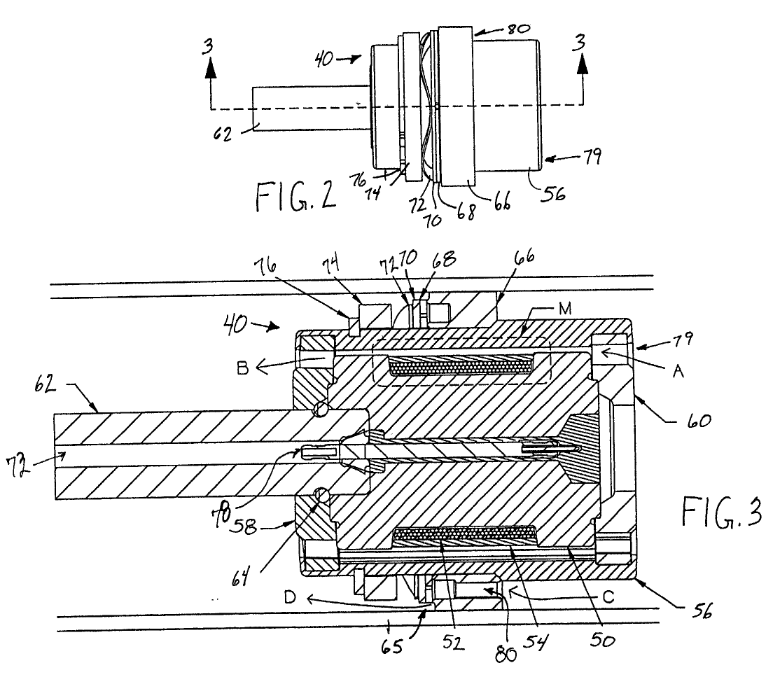

Referring to FIGS. 2-4, a piston assembly of the present invention for use in a damper is illustrated and indicated generally at 40. The assembly 40 may include a magnetic core 50. The magnetic core 50 may be made of mild steel or other suitable magnetic material. The core 50 may include a coil 52 and suitable electrical connectors or connections to provide the coil with electric current and a connection 78 to one or more external control devices, such as, for example, a system including a computer and sensors on the vehicle (not shown), which may be positioned in an axial opening 73 of the piston rod 62. The coil 52 may be held in position about or to the core 50 by a plastic over molding or covering 54.

A shell portion 56 of the piston assembly 40 may also be made of a magnetic material. The shell portion 56 may be positioned about the core 50 and crimped together to hold together an assembly including the core 50, first and second end plates 58, 60. The shell 56 can function to maintain clamping on the rod 62 through retaining ring 64 and end plate 58. The shell portion 56 can be positioned about the core 50 to define a first passageway 79 therebetween.

A control valve assembly 65 can include seat 66, which may be secured by brazing or other suitable means to the shell 56. An orifice disc 68, a valve disc 70 and a wavy washer or spring 72 can be installed against the valve seat 66. It will be understood that discs 68 and 70 may be a single combined disc or washer or a plurality of discs or washers. Orifice disc 68 may include a plurality of outer notches 69 or the like for permitting passage of fluid therethrough regardless of whether the disc 68 is seated against the seat 66. Spring 72 can be a wavy washer, Belleville spring or other suitable spring device or mechanism that provides a bias against plate 70. A spacer 74 and a retaining ring 76 can be provided to retain the spring 72 to press the orifice disc 68 and the valve plate 70 against the valve seat 66. The spacer 74, spring 72, valve disc 70, orifice disc 68, and a valve seat 66 may be made of magnetically inert material, such as stainless steel.

In operation, when the unit is stroked, magnetorheological fluid flows through, and is subject to control in, two areas of the piston. The arrow directions at A-D indicate flow of fluid during a compression stroke (shortening) and would be reversed for a rebound stroke.

The flow indicated by arrows A and B, through first flow passageway 79 can be controlled by the magnetic field generated when coil 52 is energized. Electrical current in the coil 52 may generate a magnetic field shown as M in the core 50 and the shell 56 and across the flow path 79 as shown. Magnetorheological fluid, typically a mixture including oil and small particles of iron, becomes resistant to flow, or exhibits an increased apparent viscosity when a magnetic field is applied thereto. By varying the current in the coil 52, the magnetic field shown by M can be varied and damping force generated within this flow path is varied accordingly. The damping effect in the flow path (indicated by arrows A and B) is essentially the same for compression and rebound stroke or damping events when the current through the coil 52 is the maintained at the same value.

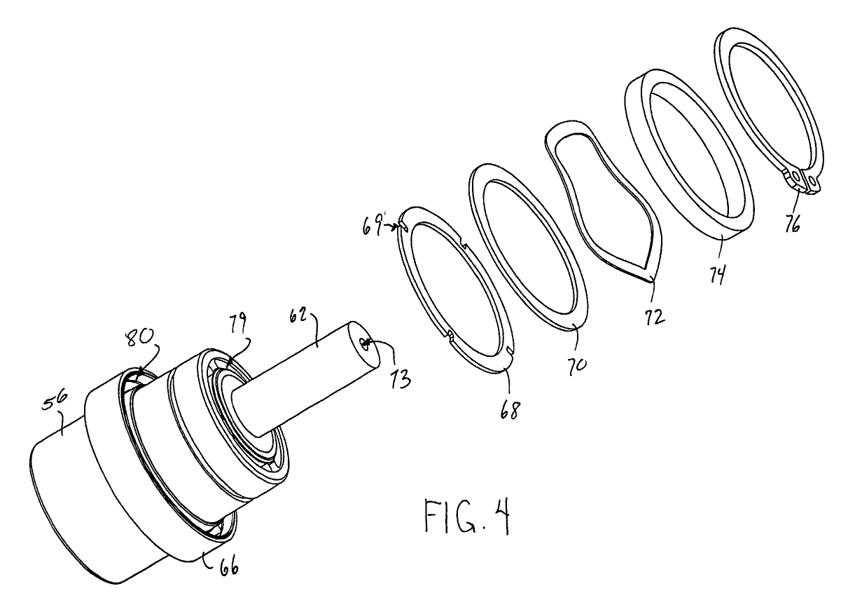

Flow, as indicated by arrows C and D, is allowed under all conditions by the orifice disc 68 (if present). During a rebound stroke, orifice flow only is permitted. During a compression stroke, additional flow is permitted when enough fluid pressure is generated to deflect the spring 72. At this time, flow is controlled by the amount of lift of the valve disc 70, and the orifice disc 68 and the dimensions of the openings provided to the valve seat 66. The one or more openings in valve seat 66 are shown in FIGS. 3 and 4 at 80. The fluid pressure working against the spring 72 may control lift off of the valve disc 70 in response to fluid pressure applied to the valve disc. Spacer 74 may be installed as required to adjust the force applied by the spring 72. In other words, the thicker the spacer 74, the more force is required to unseat disc 68, 70 against the bias of spring 72. It will be understood that no extra control need be applied to this flow.

The performance resulting from the two flow paths together provides compression damping which is a function of the combination of the external control path (A, B) and preset pressure regulated bypass path (C, D). Rebound damping is controlled primarily through the externally controllable path (A, B). This permits compression damping to be controlled within a more desired range, when compared to rebound damping.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. An adjustable damper comprising:
a tube;
a piston slidably positioned in the tube;
a coil operably positioned adjacent a first flow passageway in the piston to produce a magnetic field thereacross; and
a control valve operably attached to the piston to control fluid flow through a second flow passageway in the piston.

2. The damper of claim 1 wherein the first flow passageway and tube includes a magnetorheological fluid.

3. The damper of claim 2 wherein the magnetic field produced across the first flow passageway changes the apparent viscosity of at least a portion of the magnetorheological fluid present therein.

4. The damper of claim 1 wherein the control valve is permitted to open during compression strokes of the damper.

5. The damper of claim 4 wherein the control valve is substantially closed during extension strokes of the damper.

6. The damper of claim 1 wherein the control valve includes a first disc that permits a first amount of flow through the control valve during both compression strokes and extension strokes of the damper.

7. The damper of claim 6 wherein the first disc is a washer including a plurality of outer notches.

8. The damper of claim 6 wherein the first disc permits a second amount of flow through the control valve during compression strokes, the first amount of flow being less than the second amount of flow.

9. The damper of claim 7 wherein the first disc is biased against a valve seat portion of the control valve by a spring member.

10. The damper of claim 9 wherein the spring member is a wavy washer.

11. The damper of claim 9 wherein the spring member is a Belleville washer.

12. The damper of claim 8 wherein a second disc is positioned between the first disc and the spring member.

13. The damper of claim 12 wherein the second disc is a solid washer.

14. The damper of claim 8 wherein the control valve includes a retaining member positioned to retain the spring member and the first disc against the valve seat portion.

15. The damper of claim 14 wherein a spacer is positioned between the retaining member and the spring member.

16. The damper of claim 15 wherein the spacer provides a predetermined preload to the spring member.

17. A method of controlling an adjustable damper comprising:
enclosing a piston in a magnetorheological fluid;
generating a magnetic field in a first passageway of the piston to produce an apparent viscosity change in the magnetorheological fluid responsive to the magnetic field; and
controlling the fluid flow through a second passageway of the piston.

18. The method of claim 17 wherein controlling the fluid flow through the second passageway includes providing a first flow through the second passageway during an extension stroke and providing a second flow through during a compression stroke, the first flow being substantially less than the second flow.

19. An adjustable damper comprising:
means for slidably enclosing a piston in a magnetorheological fluid;
means for generating a magnetic field in a first passageway of the piston; and
means for controlling the fluid flow through a second passageway of the piston.

20. The damper of claim 19 further comprising:
means for producing an apparent viscosity change in the magnetorheological fluid responsive to the magnetic field.
